(19) United States
(12) Patent Application Publication
(10) Pub. No.: US 2024/0306075 A1
(43) Pub. Date: Sep. 12, 2024

(54) METHODS OF HANDLING WIRELESS TRANSMISSIONS

(71) Applicant: Realtek Semiconductor Corporation, Hsinchu (TW)

(72) Inventors: John Timothy COFFEY, San Francisco, CA (US); Der-Zheng LIU, Hsinchu (TW)

(21) Appl. No.: 18/594,310

(22) Filed: Mar. 4, 2024

Related U.S. Application Data
(60) Provisional application No. 63/488,774, filed on Mar. 7, 2023.

(51) Int. Cl. H04W 48/08; H04W 74/08

(52) U.S. Cl. CPC H04W 48/08; H04W 74/08

(57) ABSTRACT

A method of handling wireless transmissions in a wireless communication system is disclosed. The method includes: transmitting, by a first wireless communication device, an announcement packet, in which the announcement packet includes a source network identifier, a permitted network identifier, a permitted transmission power level corresponding to the permitted network identifier, and a channel access delay corresponding to the permitted network identifier; starting, by a second wireless communication device with the source network identifier, a first transmission at a normal transmission power level; and starting, by a third wireless communication device with the permitted network identifier, a second transmission at a limited power level not higher than the permitted transmission power level after the channel access delay from a time at which the first wireless communication device starts transmitting the announcement packet.

### RELATED APPLICATIONS

This application claims priority to U.S. Provisional Application Ser. No. 63/488,774, filed Mar. 7, 2023, which is herein incorporated by reference.

### BACKGROUND

### Technical Field

The present disclosure relates to wireless transmission technology, and more particularly to methods of handling wireless transmissions in the same general vicinity.

### Description of Related Art

The IEEE 802.11ax standard specifies a spatial reuse mechanism, of which the purpose is to reuse a wireless medium in a same frequency band of overlapped basic service sets (BSSs), thereby increasing usage efficiency of the frequency band. However, the BSSs become closer with densification of wireless communication systems, and interference between the BSSs also increases, thus affecting the transmissions of the overall system.

### SUMMARY

One aspect of the present disclosure directs to a method of handling wireless transmissions in a wireless communication system. The method includes: transmitting, by a first wireless communication device, an announcement packet, in which the announcement packet includes a source network identifier, a permitted network identifier, a permitted transmission power level corresponding to the permitted network identifier, and a channel access delay corresponding to the permitted network identifier; starting, by a second wireless communication device with the source network identifier, a first transmission at a normal transmission power level; and starting, by a third wireless communication device with the permitted network identifier, a second transmission at a limited power level not higher than the permitted transmission power level after the channel access delay from a time at which the first wireless communication device starts transmitting the announcement packet.

Another aspect of the present disclosure directs to a method of handling wireless transmissions in a wireless communication system. The method includes: sending, by a first wireless communication device, an announcement packet, in which the announcement packet includes a first set of permitted network identifiers, a second set of permitted network identifiers, a first permitted transmission power level corresponding to the first set of permitted network identifiers, a second permitted transmission power level corresponding to the second set of permitted network identifiers, a first channel access delay corresponding to the first set of permitted network identifiers, and a second channel access delay corresponding to the second set of permitted network identifiers; starting, by a second wireless communication device with one of the first permitted network identifiers, a first transmission at a first limited power level not higher than the first permitted transmission power level after the first channel access delay from a time at which the first wireless communication device starts transmitting the announcement packet; and starting, by a third wireless communication device with one of the second set of permitted network identifiers, a second transmission at a second limited power level not higher than the second permitted transmission power level after the second channel access delay from the time at which the first wireless communication device starts transmitting the announcement packet.

Yet another aspect of the present disclosure directs to a method of handling wireless transmissions in a wireless communication system. The method includes: starting, by a first wireless communication device, a first transmission at a normal transmission power level with a packet preamble, in which the packet preamble includes a source network identifier, a permitted network identifier, a permitted transmission power level corresponding to the permitted network identifier, and a channel access delay corresponding to the permitted network identifier; and starting, by a second wireless communication device with the permitted network identifier, a second transmission at a limited power level not higher than the permitted transmission power level after the channel access delay from a time at which the first wireless communication device starts the first transmission.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is a schematic block diagram of the wireless transceiver device in accordance with some embodiments of the present disclosure.

FIG. 3 is a flowchart of a method of handling wireless transmissions in accordance with some embodiments of the present disclosure.

FIG. 4 exemplarily illustrates a first scenario of a spatial reuse transmission adopting the method in FIG. 3.

FIG. 5 is a flowchart of a method of handling wireless transmissions in accordance with some embodiments of the present disclosure.

FIG. 6 exemplarily illustrates a second scenario of a spatial reuse transmission adopting the method in FIG. 5.

FIG. 7 is a flowchart of a method of handling wireless transmissions in accordance with some embodiments of the present disclosure.

FIG. 8 exemplarily illustrates a third scenario of a spatial reuse transmission adopting the method in FIG. 7.

### DETAILED DESCRIPTION

The detailed explanation of the present disclosure is described as following. The described preferred embodiments are presented for purposes of illustrations and description, and they are not intended to limit the scope of the present disclosure.

In the present disclosure, wireless transceiver devices can be used to represent a number of different embodiments, including but not limited to, mobile wireless transceiver devices such as stations (STAs), laptops, mobile phones, tablet computers, access points (APs), routers, switches, computer equipment, server equipment, workstations, and/or other fixed wireless transceiver devices. In addition, wireless transceivers can support multiple-input multiple-output (MIMO) transmissions, multiple-input single-output (MISO) transmissions, single-input multiple-output (SIMO) transmissions, and/or single-input single-output (SISO) transmissions.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and/or Extremely High Throughput (EHT) modes, in which the HT modes, the VHT modes, the HE modes, and the EHT modes respectively correspond to various generations of wireless local area networks (WLANs) such as Wi-Fi 4, Wi-Fi 5, Wi-Fi 6, and Wi-Fi 7. More transmission modes are usable for a wireless transceiver device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

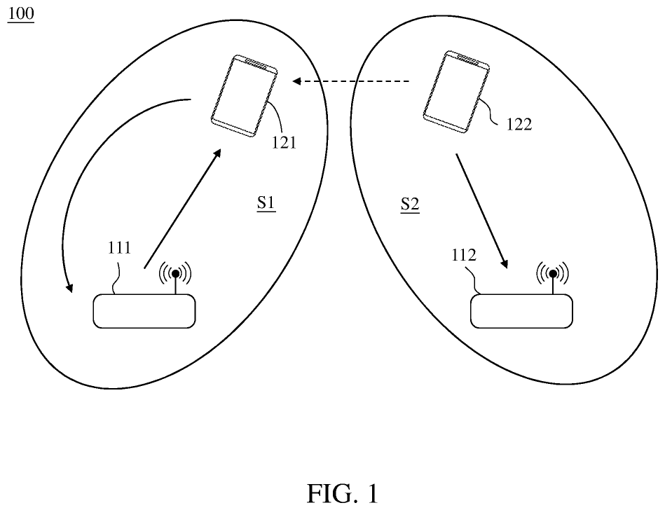

FIG. 1 is a schematic diagram of a wireless communication system 100 in accordance with some embodiments of the present disclosure. The wireless communication system 100 includes wireless access point devices 111 and 112, and wireless terminal devices 121 and 122. The wireless communication system 100 supports Wi-Fi the system specifications. The wireless access point devices 111 and 112, and wireless terminal devices 121 and 122 may be access points (APs) and stations (STAs) in the Wi-Fi system specification, respectively. The wireless access point devices 111 and 112 respectively provide wireless access services within a certain range, and the wireless terminal devices 121 and 122 may perform wireless communication connections respectively with the wireless access point devices 111 and 112 through a Wi-Fi channel (e.g., an IEEE 802.11 channel) to access a local network and/or an external network (e.g., the Internet). The wireless communication connection between the wireless access point device 111 and the wireless terminal device 121, and the wireless communication connection between the wireless access point device 112 and the wireless terminal device 122 may include, but are not limited to, registration procedures, authentication procedures and access procedures, the establishment and release of wireless connections, and the transmission and/or reception of control signals and/or the transmission and/or reception of data signals, etc.

As shown in FIG. 1, the wireless access point device 111 and the wireless terminal device 121 correspond to a basic service set (BSS) S1, and the wireless access point device 112 and the wireless terminal device 122 correspond to a BSS S2. For the wireless access point device 111 and the wireless terminal device 121 corresponding to the BSS S1, the BSS S2 is an OBSS. Similarly, for the wireless access point device 112 and the wireless terminal device 122 corresponding to the BSS S2, the BSS S1 is an OBSS. The wireless communication system 100 supports technologies such as spatial reuse and BSS coloring.

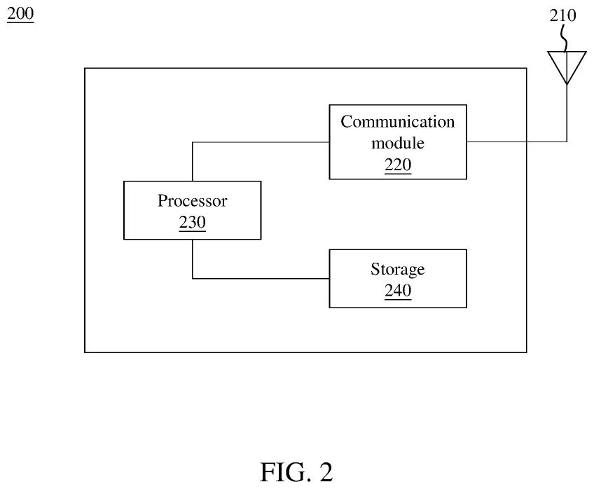

FIG. 2 is a schematic block diagram of the wireless transceiver device 200 in accordance with some embodiments of the present disclosure. The wireless transceiver device 200 may be any one of the wireless access point devices 111-112 and the wireless terminal devices 121-122 in FIG. 1, or any wireless communication device in the following embodiments of the present disclosure. The wireless transceiver device 200 includes an antenna 210, a communication module 220, a processor 230, and a storage 240. The antenna 210 is configured for wireless transmissions and/or receptions by transmitting and/or receiving radio frequency (RF) signals. In some embodiments, the wireless transceiver device 200 may include plural antennas 210 used to transmit and receive RF signals with multiple inputs and/or multiple outputs. The communication module 220 is coupled with the antenna 210 and is configured to receive and demodulate an RF signal as a packet (such as a control signal or a data signal) and modulate a packet to be transmitted into an RF signal. The processor 230 is coupled with the communication module 220 and the storage 240, and is configured to process the packet and determine the transmission mode of the communication module 220 according to the system state for transmitting and receiving signals. The processor 230 may be, but is not limited to, e.g., a microprocessor or an application-specific integrated circuit (ASIC). The storage 240 may be any data storage device that can be read and executed by the processor 230. The storage 240 may be, for example, a subscriber identity module (SIM), a read-only memory (ROM), an erasable programmable ROM (EPROM), an electrically erasable programmable ROM (EEPROM), random access memory (RAM), CD-ROM, magnetic tape, hard disk, solid-state drive, flash memory, or other data storage device suitable for storing bits and/or code, including, but not limited to.

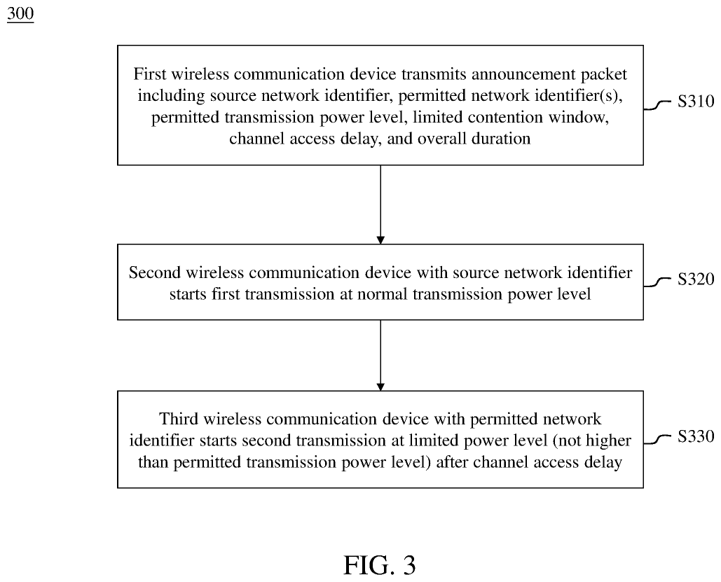

FIG. 3 is a flowchart of a method 300 of handling wireless transmissions in accordance with some embodiments of the present disclosure. The method 300 is suitable for a wireless communication system that supports technologies such as spatial reuse and BSS coloring, such as the wireless communication system 100 in FIG. 1.

In Operation S310, a first wireless communication device of the wireless communication system transmits an announcement packet including a source network identifier, permitted network identifier(s), a permitted transmission power level corresponding to the permitted network identifier(s), a limited contention window corresponding to the permitted network identifier(s), a channel access delay corresponding to the permitted network identifier(s), and an overall duration. The source network identifier is the network identifier to which the first wireless communication device corresponds, and the permitted network identifier(s) include network identifier(s) other than the source network identifier. In some examples, the source network identifier and the permitted network identifier(s) are various BSS colors (e.g., a first BSS color and a second BSS color of the wireless communication system, respectively). The permitted transmission power level is the maximum transmission power level (for example, a bit sequence mapping to 0 dBm) for a wireless communication device in the wireless communication system corresponding to the permitted network identifier(s) to perform a transmission after the channel access delay according to (e.g., during) the method 300. The permitted transmission power level may be encoded as a set of bit mappings to a permitted transmission power table that is prestored in the first wireless communication device. The devices corresponding to the permitted network identifier(s) are permitted to access the wireless medium within the limited contention window and after the channel access delay. The overall duration indicates expiration of the announcement packet.

In Operation S320, a second wireless communication device with the source network identifier starts a first transmission (e.g., to the first wireless communication device or another device corresponding to the source network identifier) at a normal transmission power level. The second wireless communication device starts the first transmission after winning the contention for the wireless medium under a normal contention mechanism, e.g., carrier sense multiple access with collision avoidance (CSMA/CA). The first transmission is a normal transmission relative to a spatial reuse transmission. The normal transmission power level for the first transmission is not restricted to the permitted transmission power level. That is, the normal transmission power level is higher than the permitted transmission power level.

In Operation S330, a third wireless communication device with the permitted network identifier starts a second transmission at a limited power level (not higher than the permitted transmission power level) after the channel access delay from the time at which the announcement packet is transmitted. The third wireless communication device starts the second transmission after winning the contention for the wireless medium under a spatial reuse contention mechanism. The second transmission is a contention-based spatial reuse transmission of which the transmission power level is restricted not to be higher than the permitted transmission power level (i.e., at most the permitted transmission power level lower than the normal transmission power level). The third wireless communication device may start the second transmission within the limited contention window after the channel access delay from the time at which the announcement packet is transmitted. In particular, the backoff counter of the third wireless communication device starts from a number less than the limited contention window and that of each device corresponding to one of the permitted network identifier(s), and the third wireless communication device starts the second transmission when the backoff counter thereof reaches zero. The third wireless communication device completes the second transmission before the overall duration expires.

The method 300 ends after the overall duration expires from the time at which the first wireless communication device transmits the announcement packet. In the method 300, the first and second wireless communication devices may be respectively a wireless access point device and a wireless terminal device corresponding to the same network identifier (e.g., the same BSS color), and the third wireless communication device may be a wireless terminal device corresponding to another network identifier (e.g., another BSS color). For example, if the method 300 is adopted in the wireless communication system 100 in FIG. 1, the first to third communication devices may be the wireless access point device 111 and the wireless terminal devices 121 and 122, respectively.

In some embodiments, the parameters of the source network identifier, the permitted network identifier(s), the permitted transmission power level, the limited contention window, the channel access delay, and/or the overall duration may be communicated over the wireless medium by an advanced transmission (i.e., a transmission that informs other devices of the above parameters to be used in a future time duration) or as part of an ongoing transmission (i.e., a transmission that has achieved channel access by any mechanism, such as a normal contention mechanism, a spatial reuse contention mechanism, or the like, and that establishes the above parameters for other devices to transmit during the same duration) from the first wireless communication device.

In certain embodiments, maximum durations for the first and second transmissions may also be included in the announcement packet. For example, the first transmission of the second wireless communication device may be limited to a duration that terminates before the channel access delay from the time at which the first wireless communication device transmits the announcement packet. The second wireless communication device accesses the wireless medium according to (e.g., during) the method 300 to provide information about overall data transmission requirements (such as the amount of data to be transmitted by the second wireless communication device, the requested priority of the data, information about the interference levels experienced at the second wireless communication devices from the devices of different network identifier(s) and/or other specified devices, and so on), rather than providing the actual data. These embodiments permit the first wireless communication device to configure the parameters in the announcement packet (e.g., address specific devices or groups of devices) to govern the transmissions during the overall duration.

In some other embodiments, instead of exclusively using network identifiers, the first wireless communication device may specify, either individual devices, via addresses or partial addresses, or groups of individual devices, or a mixture of individual devices and network identifiers to govern the transmissions during the overall duration.

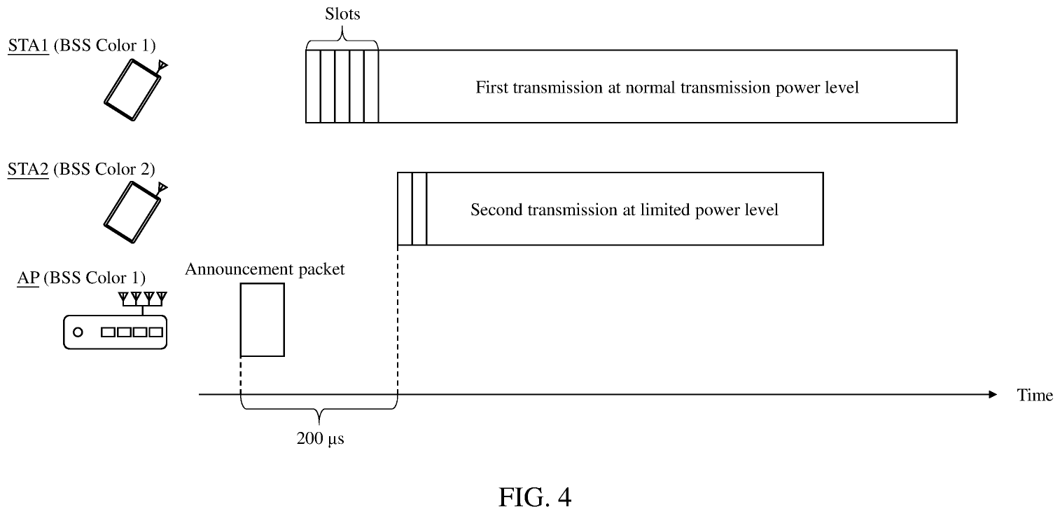

FIG. 4 exemplarily illustrates a first scenario of a spatial reuse transmission adopting the method 300. In the first scenario, the first wireless communication device is a wireless access point device (denoted as AP), and the second and third wireless communication devices are wireless terminal devices (respectively denoted as STA1 and STA2), in which the wireless access point device AP and the wireless terminal device STA1 correspond to a first BSS color (BSS Color 1), and the wireless terminal device STA2 correspond to a second BSS color (BSS Color 2).

First, the wireless access point device AP transmits announcement packet(s) including a source BSS color of “BSS Color 1”, a permitted BSS color of “all other Colors”, a permitted transmission power level of 0 dBm, a limited contention window of 3 slots, a channel access delay of 200 μs, and an overall duration of 3 ms. “BSS Color 1” represents the first BSS color, and “all other Colors” includes all BSS colors (including the second BSS color) in the wireless communication system except the first BSS color.

After the wireless access point device AP transmits the announcement packet, all wireless terminal devices corresponding to the first BSS color start contending for the wireless medium. As shown in FIG. 4, the wireless terminal device STA1 starts the backoff counter thereof from 5, and starts transmitting at a normal transmission power level (e.g., 10 dBm) in a condition where no wireless terminals device corresponding to the first BSS color is detected thereby in any slot earlier than the fifth slot.

Then, after 200 μs from the time at which the wireless access point device AP transmits the announcement packet, the wireless communication devices corresponding to the BSS colors other than the first BSS color may start contending for the wireless medium within 3 slots. In the first scenario, the wireless terminal device STA2 wins the contention after 2 slots, and starts transmitting at the transmission power level of at most 0 dBm.

In FIG. 4, the transmissions of the wireless terminal devices STA1 and STA2 are overlapped. In another example, the transmissions of the wireless terminal devices STA1 and STA2 may not overlap. That is, the wireless terminal device STA2 may start transmitting after the transmission of the wireless terminal device STA1 ends. The method 300 ends after 3 ms from the time at which the wireless access point device AP transmits the announcement packet.

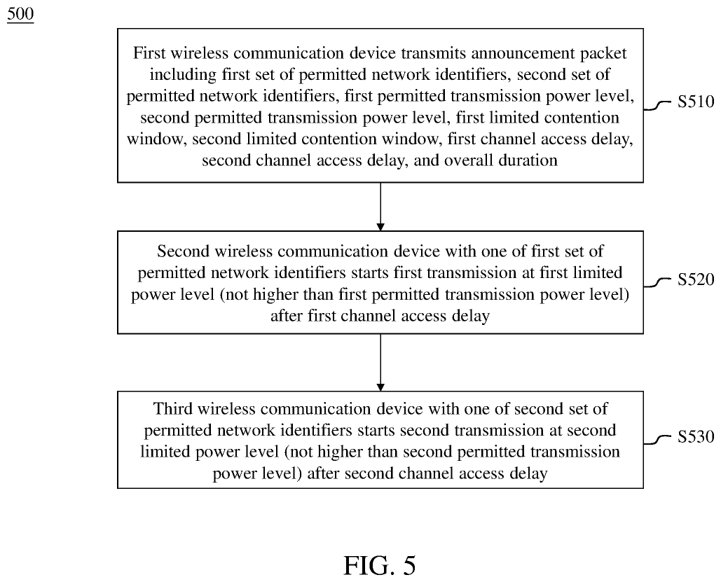

FIG. 5 is a flowchart of a method 500 of handling wireless transmissions in accordance with some embodiments of the present disclosure. The method 500 is suitable for a wireless communication system that supports technologies such as spatial reuse and BSS coloring, e.g., the wireless communication system 100 in FIG. 1.

In Operation S510, a first wireless communication device of the wireless communication system transmits an announcement packet including a first set of permitted network identifiers, a second set of permitted network identifiers, a first permitted transmission power level corresponding to the first set of permitted network identifiers, a second permitted transmission power level corresponding to the second set of permitted network identifiers, a first limited contention window corresponding to the first set of permitted network identifiers, a second limited contention window corresponding to the second set of permitted network identifiers, a first channel access delay corresponding to the first set of permitted network identifiers, a second channel access delay corresponding to the second set of permitted network identifiers, and an overall duration. The first set of permitted network identifiers may be, but does not have to be, non-overlapped with the second set of permitted network identifiers. The first permitted transmission power level is the maximum transmission power level (for example, a bit sequence mapping to 10 dBm) for a wireless communication device in the wireless communication system with one of the first set of permitted network identifiers to perform a transmission after the first channel access delay according to (e.g., during) the method 500, and the second permitted transmission power level is the maximum transmission power level (for example, a bit sequence mapping to 0 dBm) for a wireless communication device in the wireless communication system with one of the second set of permitted network identifiers to perform a transmission after the second channel access delay according to (e.g., during) the method 500. The second channel access delay is longer than the first channel access delay. Each of the first and second permitted transmission power levels may be encoded as a set of bit mappings to a permitted transmission power table that is prestored in the first wireless communication device. The devices corresponding to the first permitted network identifier(s) are permitted to access the wireless medium within the first limited contention window and after the first channel access delay, and the devices corresponding to the second permitted network identifier(s) are permitted to access the wireless medium within the second limited contention window and after the second channel access delay. The first limited contention window may be larger than the second limited contention window. The overall duration indicates expiration of the announcement packet.

In Operation S520, a second wireless communication device corresponding to the first set of permitted network identifiers (e.g., a network identifier belonging to the first set of permitted network identifiers) starts a first transmission at a first limited power level (not higher than the first permitted transmission power level) after the first channel access delay from the time at which the first wireless communication device starts transmitting the announcement packet. The second wireless communication starts the first transmission after winning the contention for the wireless medium under a normal contention mechanism, a spatial reuse contention mechanism, or another suitable contention mechanism. The second wireless communication device may start the first transmission within the first limited contention window after the first channel access delay from the time at which the first wireless communication device starts transmitting the announcement packet. In particular, the backoff counter of the second wireless communication device starts from a number less than the first limited contention window and that of each device corresponding to one of the first set of permitted network identifiers, and the second wireless communication device starts the first transmission when the backoff counter thereof reaches zero.

In Operation S530, a third wireless communication device corresponding to the second set of permitted network identifiers starts a second transmission at a second limited power level (not higher than the second permitted transmission power level) after the second channel access delay from the time at which the first wireless communication device starts transmitting the announcement packet. The third wireless communication device may start the second transmission after winning the contention for the wireless medium under a spatial reuse contention mechanism, and the transmission power level for the second transmission is restricted not to be higher than the second permitted transmission power level (i.e., at most the second permitted transmission power level). The third wireless communication device may start the second transmission within the second limited contention window after the second channel access delay from the time at which the first wireless communication device starts transmitting the announcement packet. In particular, the backoff counter of the third wireless communication device starts from a number less than the second limited contention window and that of each device corresponding to one of the second permitted network identifier(s), and the third wireless communication device starts the second transmission when the backoff counter thereof reaches zero.

In some embodiments, the first and second permitted transmission power levels are the same, and/or the first set of permitted network identifiers and the second set of permitted network identifiers may have the same network identifier(s).

In the method 500, multiple channel access delays permit devices to organize sets of permitted network identifiers that work well together, in the sense of permitting successful simultaneous transmissions at advantageous transmission power levels. For example, the network corresponding to the source network identifier and the networks corresponding to the first set of permitted network identifiers, while in the same general vicinity, are separated enough in distance to work well simultaneously.

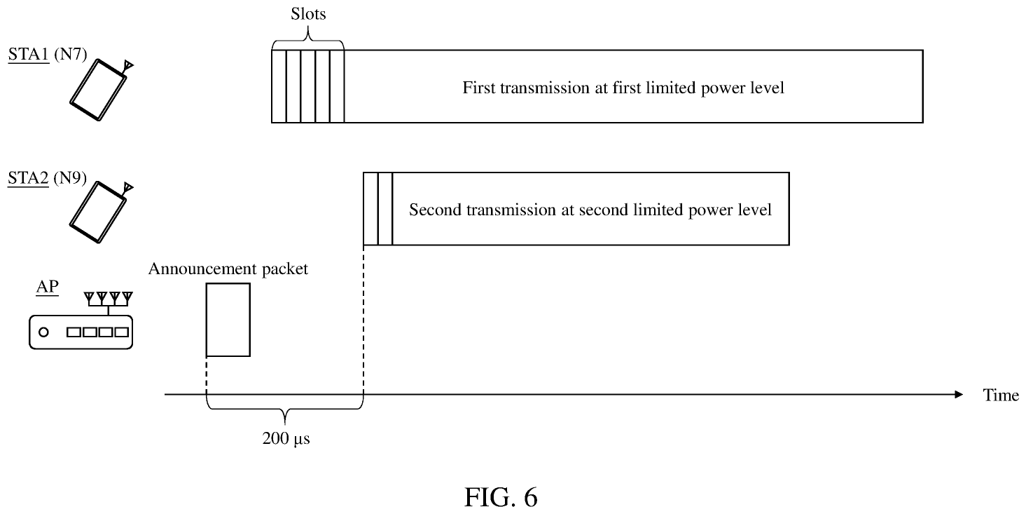

FIG. 6 exemplarily illustrates a second scenario of a spatial reuse transmission adopting the method 500. In the second scenario, the first wireless communication device is a wireless access point device (denoted as AP), and the second and third wireless communication devices are wireless terminal devices (respectively denoted as STA1 and STA2), in which the wireless terminal device STA1 correspond to a network identifier “N7” that belongs to the first set of permitted network identifiers “N2, N5, and N7”, and the wireless terminal device STA2 corresponds to a network identifier “N9” that belongs to a second set of permitted network identifiers but does not belong to the first set of permitted network identifiers.

First, the wireless access point device AP transmits announcement packet(s) including the first set of permitted network identifiers, the second set of permitted network identifiers of “all other identifiers”, a permitted transmission power level of 0 dBm, a limited contention window of 3 slots, a channel access delay of 200 μs, and an overall duration of 3 ms. The information “all other identifiers” represents all network identifiers (including those in the second set of permitted network identifiers) in the wireless communication system except those in the first set of permitted network identifiers.

After the wireless access point device AP transmits the announcement packet, the terminal devices corresponding to the first set of permitted network identifiers start contending for the wireless medium. As shown in FIG. 6, the wireless terminal device STA1 starts the backoff counter thereof from 5, and then starts transmitting at the first permitted transmission power level (e.g., 10 dBm) in a condition where no terminals device corresponding to the first set of permitted network identifiers is detected thereby in any slot earlier than the fifth slot.

Then, after 200 μs from the time at which the wireless access point device AP transmits the announcement packet, the wireless communication devices corresponding to “all other identifiers” may start contending for the wireless medium within 3 slots. In the second scenario, the wireless terminal device STA2 wins the contention after 2 slots, and starts transmitting at the second permitted transmission power level (e.g., 0 dBm) in a condition where no terminals device corresponding to the second set of permitted network identifiers is detected thereby in any slot earlier than the third slot.

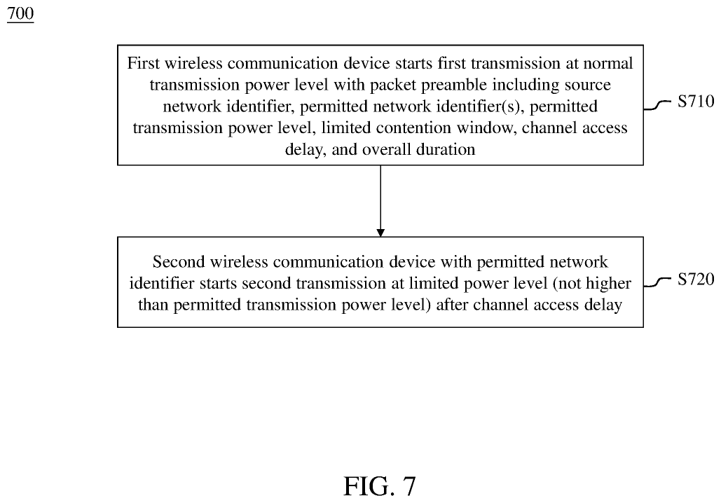

FIG. 7 is a flowchart of a method 700 of handling wireless transmissions in accordance with some embodiments of the present disclosure. The method 700 is suitable for a wireless communication system that supports technologies such as spatial reuse and BSS coloring, e.g., the wireless communication system 100 in FIG. 1.

In Operation S710, a first wireless communication device of the wireless communication system starts a first transmission at a normal transmission power level with a packet preamble (or header) including a source network identifier, permitted network identifier(s), a permitted transmission power level corresponding to the permitted network identifier(s), a limited contention window corresponding to the permitted network identifier(s), a channel access delay corresponding to the permitted network identifier(s), and an overall duration. The first wireless communication device starts the first transmission after winning the contention for the wireless medium under a normal contention mechanism. The source network identifier, the permitted network identifier(s), the permitted transmission power level, the channel access delay, and the limited contention window may be respectively similar to those in the method 300, and thus the detailed descriptions thereof are not repeated herein. The overall duration indicates expiration of the packet preamble. The normal transmission power level for the first transmission is not restricted to the permitted transmission power level. That is, the normal transmission power level is higher than the permitted transmission power level. In some examples, the source network identifier and the permitted network identifier(s) are various BSS colors (e.g., a first BSS color and a second BSS color of the wireless communication system, respectively).

In Operation S720, a second wireless communication device with the permitted network identifier starts a second transmission at a limited power level (not higher than the permitted transmission power level) after the channel access delay from the time at which the first wireless communication device starts the first transmission. The second wireless communication device starts the second transmission after winning the contention for the wireless medium under a spatial reuse contention mechanism. The second transmission is a contention-based spatial reuse transmission of which the transmission power level is restricted not to be higher than the permitted transmission power level (i.e., at most the permitted transmission power level). The second wireless communication device may start the second transmission within the limited contention window after the channel access delay from the time at which the announcement packet is transmitted. In particular, the backoff counter of the second wireless communication device starts from a number less than the limited contention window and that of each device corresponding to one of the permitted network identifier(s), and the second wireless communication device starts the second transmission when the backoff counter thereof reaches zero.

The method 700 ends after the overall duration expires from the time at which the first wireless communication device starts the first transmission. In the method 700, the first and second wireless communication devices may be wireless terminal devices corresponding to different network identifiers. For example, if the method 700 is adopted in the wireless communication system 100 in FIG. 1, the first and second communication devices may be the wireless terminal devices 121 and 122, respectively.

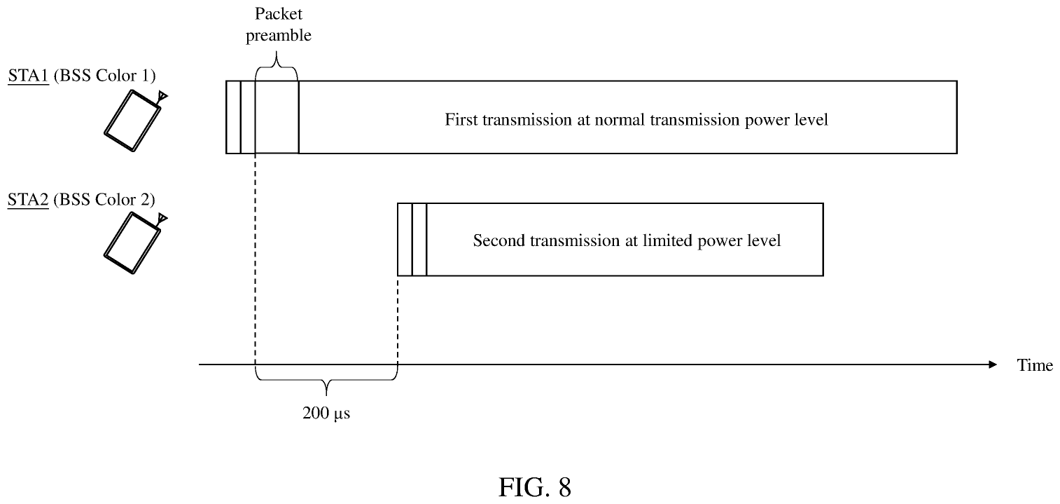

FIG. 8 exemplarily illustrates a third scenario of a spatial reuse transmission adopting the method 700. In this scenario, the first and second wireless communication devices are wireless terminal devices (respectively denoted as STA1 and STA2) respectively corresponding to a first BSS color (BSS Color 1) and a second BSS color (BSS Color 2).

First, the wireless terminal device STA1 gains access to the wireless medium, and starts a transmission with a packet preamble (or header) including a permitted BSS color of “all other Colors”, a permitted transmission power level of 0 dBm, a limited contention window of 3 slots, a channel access delay of 200 μs, and an overall duration of 3 ms. The information “all other Colors” represents all BSS colors (including the second BSS color) in the wireless communication system except the first BSS color.

After 200 μs from the time at which the wireless terminal device STA1 starts the transmission with the packet preamble (or header), the wireless terminal devices corresponding to the BSS colors other than the first BSS color may start contending for the wireless medium within 3 slots. In the third scenario, the wireless terminal device STA2 wins the contention after 2 slots, and starts transmitting at the transmission power level of at most 0 dBm.

In FIG. 8, the transmissions of the wireless terminal devices STA1 and STA2 are overlapped. In another example, the transmissions of the wireless terminal devices STA1 and STA2 may not overlap. That is, the wireless terminal device STA2 may start transmitting after the transmission of the wireless terminal device STA1 ends. The method 700 ends after 3 ms from the time at which the wireless terminal device STA1 starts the transmission with the packet preamble (or header).

It is noted that in the present disclosure, instead of coming from a single device, the initiating transmission (i.e., transmission of an announcement packet) may be split between multiple devices, containing the same information in aggregate as could have been defined by a single device. For example, and without limitation, two or more wireless access points devices may, in effect, negotiate agreements for joint transmissions via a sequence of packets, in such a way that other devices in the same general vicinity may derive a unified set of permissions and restrictions that would have the same force as if issued by a single wireless access points device. In addition, during each method disclosed herein, devices may be permitted to respond to transmissions, e.g., by sending acknowledgements.

Embodiments of the present disclosure provide at least the advantages as follows. The permitted transmission power level for devices other than those corresponding to the source network identifier is added so that any transmission from these devices (corresponding to one or more network identifiers other than the source network identifier) is unlikely to interfere with a main transmission (e.g., by a device corresponding to the source network identifier) to the extent of causing transmission failure. In addition, the limited contention window is added to solve the problem that devices other than those corresponding to the source network identifier will usually have to contend for the wireless medium while the main transmission is in progress and thus results in difficulty for the extra devices to determine whether some other device(s) with the same network identifier has accessed the wireless medium, and ameliorates the effect that some devices corresponding to the same network identifier other than the source network identifier are likely to start transmitting simultaneously and thus results in a collision or increasing of the mutual interference due to many available contention slots when the number of the potential contending devices are large. Furthermore, the channel access delay for devices corresponding to network identifier(s) other than the source network identifier is intended in part to provide a method for determining the effectiveness of the parameters that have been chosen. For example, a receiver may report the quality of the received transmission before and after the channel access delay, and such information may be used by a transmitter (relative to the receiver) or other devices to adjust the parameters for future transmissions. The channel access delay also, without limitation, provides a method for the transmission to convey high priority data with low interference.

Summing the above description, the present disclosure provides a method of handling wireless transmissions in a wireless communication system including: transmitting, by a first wireless communication device, an announcement packet, in which the announcement packet includes a source network identifier, a permitted network identifier, a permitted transmission power level corresponding to the permitted network identifier, and a channel access delay corresponding to the permitted network identifier; starting, by a second wireless communication device with the source network identifier, a first transmission at a normal transmission power level; and starting, by a third wireless communication device with the permitted network identifier, a second transmission at a limited power level not higher than the permitted transmission power level after the channel access delay from a time at which the first wireless communication device starts transmitting the announcement packet. In one embodiment, the announcement packet further includes a limited contention window corresponding to the permitted network identifier, and the third wireless communication device starts the second transmission within the limited contention window after the channel access delay from the time at which the first wireless communication device starts transmitting the announcement packet. In one embodiment, the announcement packet further includes an overall duration that indicates expiration of the announcement packet. In one embodiment, the third wireless communication device completes the second transmission before the overall duration expires. In one embodiment, the permitted transmission power level is lower than the normal transmission power level of the first transmission. In one embodiment, the source network identifier and the permitted network identifier are respectively a first BSS color and a second BSS color of the wireless communication system. In one embodiment, the second wireless communication device completes the first transmission before the channel access delay from the time at which the first wireless communication device starts transmitting the announcement packet.

Summing the above description, the present disclosure further provides a method of handling wireless transmissions in a wireless communication system including: sending, by a first wireless communication device, an announcement packet, in which the announcement packet includes a first set of permitted network identifiers, a second set of permitted network identifiers, a first permitted transmission power level corresponding to the first set of permitted network identifiers, a second permitted transmission power level corresponding to the second set of permitted network identifiers, a first channel access delay corresponding to the first set of permitted network identifiers, and a second channel access delay corresponding to the second set of permitted network identifiers; starting, by a second wireless communication device with one of the first permitted network identifiers, a first transmission at a first limited power level not higher than the first permitted transmission power level after the first channel access delay from a time at which the first wireless communication device starts transmitting the announcement packet; and starting, by a third wireless communication device with one of the second set of permitted network identifiers, a second transmission at a second limited power level not higher than the second permitted transmission power level after the second channel access delay from the time at which the first wireless communication device starts transmitting the announcement packet. In one embodiment, the announcement packet further includes a first limited contention window corresponding to the first set of permitted network identifiers and a second limited contention window corresponding to the second set of permitted network identifiers, the second wireless communication device starts the first transmission within the first limited contention window after the first channel access delay from the time at which the first wireless communication device starts transmitting the announcement packet, and the third wireless communication device starts the second transmission within the second limited contention window after the second channel access delay from the time at which the first wireless communication device starts transmitting the announcement packet. In one embodiment, the first limited contention window is larger than the second limited contention window. In one embodiment, the announcement packet further comprises a limited contention window corresponding to the second set of permitted network identifiers, and the third wireless communication device starts the second transmission within the limited contention window after the second channel access delay from the time at which the first wireless communication device starts transmitting the announcement packet. In one embodiment, the announcement packet further comprises an overall duration that indicates expiration of the announcement packet. In one embodiment, the first set of permitted network identifiers is not overlapped with the second set of permitted network identifiers. In one embodiment, the second channel access delay is longer than the first channel access delay.

Summing the above description, the present disclosure provides a method of handling wireless transmissions in a wireless communication system including: starting, by a first wireless communication device, a first transmission at a normal transmission power level with a packet preamble, i in which the packet preamble includes a source network identifier, a permitted network identifier, a permitted transmission power level corresponding to the permitted network identifier, and a channel access delay corresponding to the permitted network identifier; and starting, by a second wireless communication device with the permitted network identifier, a second transmission at a limited power level not higher than the permitted transmission power level after the channel access delay from a time at which the first wireless communication device starts the first transmission. In one embodiment, the packet preamble further comprises a limited contention window corresponding to the permitted network identifier, and the second communication device starts the second transmission within the limited contention window after the channel access delay from the time at which the first wireless communication device starts the first transmission. In one embodiment, the packet preamble further comprises an overall duration that indicates expiration of the packet preamble. In one embodiment, the permitted transmission power level is lower than the normal transmission power level. In one embodiment, the source network identifier and the permitted network identifier are respectively a first BSS color and a second BSS color of the wireless communication system. In one embodiment, the first and second transmissions are overlapped.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. A method of handling wireless transmissions in a wireless communication system, the method comprising:
transmitting, by a first wireless communication device, an announcement packet, wherein the announcement packet comprises a source network identifier, a permitted network identifier, a permitted transmission power level corresponding to the permitted network identifier, and a channel access delay corresponding to the permitted network identifier;
starting, by a second wireless communication device with the source network identifier, a first transmission at a normal transmission power level; and
starting, by a third wireless communication device with the permitted network identifier, a second transmission at a limited power level not higher than the permitted transmission power level after the channel access delay from a time at which the first wireless communication device starts transmitting the announcement packet.

2. The method of claim 1, wherein the announcement packet further comprises a limited contention window corresponding to the permitted network identifier, and wherein the third wireless communication device starts the second transmission within the limited contention window after the channel access delay from the time at which the first wireless communication device starts transmitting the announcement packet.

3. The method of claim 1, wherein the announcement packet further comprises an overall duration that indicates expiration of the announcement packet.

4. The method of claim 3, wherein the third wireless communication device completes the second transmission before the overall duration expires.

5. The method of claim 1, wherein the permitted transmission power level is lower than the normal transmission power level of the first transmission.

6. The method of claim 1, wherein the source network identifier and the permitted network identifier are respectively a first BSS color and a second BSS color of the wireless communication system.

7. The method of claim 1, wherein the second wireless communication device completes the first transmission before the channel access delay from the time at which the first wireless communication device starts transmitting the announcement packet.

8. A method of handling wireless transmissions in a wireless communication system, the method comprising:
sending, by a first wireless communication device, an announcement packet, wherein the announcement packet comprises a first set of permitted network identifiers, a second set of permitted network identifiers, a first permitted transmission power level corresponding to the first set of permitted network identifiers, a second permitted transmission power level corresponding to the second set of permitted network identifiers, a first channel access delay corresponding to the first set of permitted network identifiers, and a second channel access delay corresponding to the second set of permitted network identifiers;
starting, by a second wireless communication device with one of the first set of permitted network identifiers, a first transmission at a first limited power level not higher than the first permitted transmission power level after the first channel access delay from a time at which the first wireless communication device starts transmitting the announcement packet; and
starting, by a third wireless communication device with one of the second set of permitted network identifiers, a second transmission at a second limited power level not higher than the second permitted transmission power level after the second channel access delay from the time at which the first wireless communication device starts transmitting the announcement packet.

9. The method of claim 8, wherein the announcement packet further comprises a first limited contention window corresponding to the first set of permitted network identifiers and a second limited contention window corresponding to the second set of permitted network identifiers, wherein the second wireless communication device starts the first transmission within the first limited contention window after the first channel access delay from the time at which the first wireless communication device starts transmitting the announcement packet, and wherein the third wireless communication device starts the second transmission within the second limited contention window after the second channel access delay from the time at which the first wireless communication device starts transmitting the announcement packet.

10. The method of claim 9, wherein the first limited contention window is larger than the second limited contention window.

11. The method of claim 8, wherein the announcement packet further comprises a limited contention window corresponding to the second set of permitted network identifiers, and wherein the third wireless communication device starts the second transmission within the limited contention window after the second channel access delay from the time at which the first wireless communication device starts transmitting the announcement packet.

12. The method of claim 8, wherein the announcement packet further comprises an overall duration that indicates expiration of the announcement packet.

13. The method of claim 8, wherein the first set of permitted network identifiers is not overlapped with the second set of permitted network identifiers.

14. The method of claim 8, wherein the second channel access delay is longer than the first channel access delay.

15. A method of handling wireless transmissions in a wireless communication system, the method comprising:
starting, by a first wireless communication device, a first transmission at a normal transmission power level with a packet preamble comprising a source network identifier, a permitted network identifier, a permitted transmission power level corresponding to the permitted network identifier, and a channel access delay corresponding to the permitted network identifier; and
starting, by a second wireless communication device with the permitted network identifier, a second transmission at a limited power level not higher than the permitted transmission power level after the channel access delay from a time at which the first wireless communication device starts the first transmission.

16. The method of claim 15, wherein the packet preamble further comprises a limited contention window corresponding to the permitted network identifier, and wherein the second communication device starts the second transmission within the limited contention window after the channel access delay from the time at which the first wireless communication device starts the first transmission.

17. The method of claim 15, wherein the packet preamble further comprises an overall duration that indicates expiration of the packet preamble.

18. The method of claim 15, wherein the permitted transmission power level is lower than the normal transmission power level.

19. The method of claim 15, wherein the source network identifier and the permitted network identifier are respectively a first BSS color and a second BSS color of the wireless communication system.

20. The method of claim 15, wherein the first and second transmissions are overlapped.
